(19) United States
(12) Patent Application Publication
(10) Pub. No.: US 2020/0368869 A1
(43) Pub. Date: Nov. 26, 2020

(54) FEEDING DEVICE

(71) Applicant: Chin-Chi LIN, Taichung City (TW)

(72) Inventor: Chin-Chi LIN, Taichung City (TW)

(21) Appl. No.: 16/562,988

(22) Filed: Sep. 6, 2019

(30) Foreign Application Priority Data
May 24, 2019 (CN) 201920757448.6

(51) Int. Cl. B23Q 15/013

(52) U.S. Cl. CPC B23Q 15/013

(57) ABSTRACT

A feeding device for a machining device includes a support unit, a feeding unit, and a connecting unit. The feeding unit is adapted for feeding a workpiece to be machined by the machining device. The connecting unit is connected between the support unit and the feeding unit, and includes a positioning member pivotally connected to the support unit and extending in a longitudinal direction, an adjusting member telescopically connected to the positioning member and movable relative to the positioning member to adjust a distance between the feeding unit and the support unit in the longitudinal direction, and a locking unit for releaseably locking the adjusting member on the positioning member.

### CROSS-REFERENCE TO RELATED APPLICATION

This application claims priority of Chinese Utility Model Patent Application No. 201920757448.6, filed on May 24, 2019.

### FIELD

The disclosure relates to a feeding device, more particularly to an adjustable feeding device.

### BACKGROUND

Generally, a wood sawing machine usually includes a machine body, a working table, a saw blade for machining a workpiece, and a driving device mounted to the machine body for driving the saw blade to operate.

Referring to FIG. 1, a conventional feeding device is mounted to a working table 1 of a wood sawing machine (not shown) for feeding a workpiece to be machined by the wood sawing machine. The conventional feeding device includes a support unit 2 fixed to the working table 1, a connecting unit 3 connected between the support unit 2 and a feeding unit 4 mounted to the connecting unit 3.

To facilitate machining of the workpiece, a distance between the workpiece and a saw blade of the wood sawing machine should be maintained within a predetermined range. The support unit 2 includes a positioning seat 201 disposed on the working table 1, and a plurality of clamping devices 202 disposed on an edge of the working table 1 and extending through the positioning seat 201 for fastening the conventional feeding device to the working table 1. Since the positions of the clamping devices 202 relative to the working table 1 are not adjustable, a distance between the workpiece and the saw blade is fixed. As a result, it is required to prepare several feeding devices having different sizes for feeding a workpiece to be machined by the wood sawing machine in different situations. Thus, the feeding devices having different size occupy relatively large room when not in use, so that the overall cost for machining the workpiece is increased.

Referring to FIG. 2, another conventional feeding device includes a support unit 5 mounted to a working table 1′ of another wood sawing machine, a connecting unit 6 pivotally connected to the support unit 5, and a feeding unit 7 mounted to the connecting unit 6 for feeding a workpiece to be machined. The working table 1′ is formed with multiple sets of through holes 101 allowing a plurality of screws 501 to extend through a selected set of the through holes 101 and to fasten the support unit 5 to the working table 1′. A distance between the feeding unit 7 and the saw blade (not shown) can be adjusted when the screws 501 extend through different sets of the through holes 101 at different positions. In this case, the need for preparing several feeding devices is no longer existed. However, it is required to drill a plurality of through holes in the working table 1′, and adjustment of the distance between the feeding unit 7 and the saw blade is relatively troublesome.

### SUMMARY

Therefore, an object of the disclosure is to provide a feeding device capable of alleviating at least one of the drawbacks of the conventional feeding devices.

According to one aspect of the disclosure, a feeding device for a machining device includes a support unit, a feeding unit, and a connecting unit. The feeding unit is adapted for feeding a workpiece to be machined by the machining device. The connecting unit is connected between the support unit and the feeding unit, and includes a positioning member, an adjusting member and a locking unit. The positioning member is pivotally connected to the support unit and extends in a longitudinal direction. The adjusting member is telescopically connected to the positioning member and is movable relative to the positioning member to adjust a distance between the feeding unit and the support unit in the longitudinal direction. The locking unit is for releaseably locking the adjusting member on the positioning member.

### BRIEF DESCRIPTION OF THE DRAWINGS

Other features and advantages of the disclosure will become apparent in the following detailed description of the embodiment with reference to the accompanying drawings, of which:

FIG. 1 is a schematic perspective view of a conventional feeding device for a wood sawing machine;

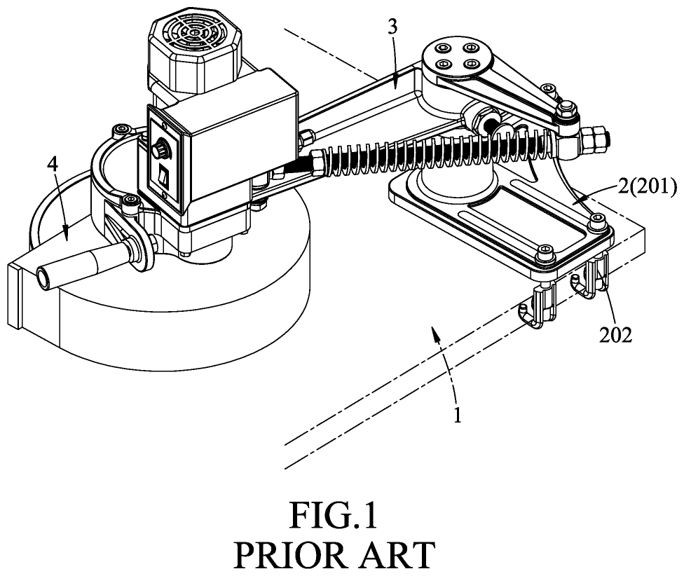

FIG. 2 is a schematic perspective view of another conventional feeding device for another wood sawing machine;

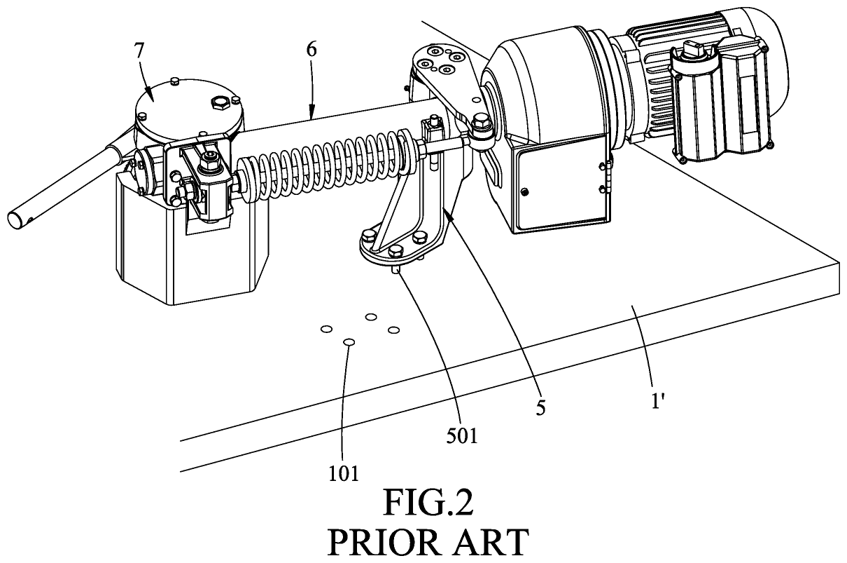

FIG. 3 is a schematic perspective view of a feeding device according to an embodiment of the present disclosure mounted on a machining device;

FIG. 4 is a schematic enlarged view of a portion of FIG. 3, illustrating the feeding device being for feeding a workpiece to be machined by the machining device;

FIG. 5 is a partly exploded perspective view of the embodiment, illustrating a connecting unit and a biasing unit mounted to a support unit of the embodiment; and

FIG. 6 is a sectional view taken along line VI-VI in FIG. 4, illustrating an adjusting member and an positioning member of the connecting unit being fastened together by two fastening elements of a locking unit of the embodiment; and

FIG. 7 is a sectional view similar to FIG. 6, illustrating a distance between a feeding unit of the embodiment and the support unit being adjusted.

### DETAILED DESCRIPTION

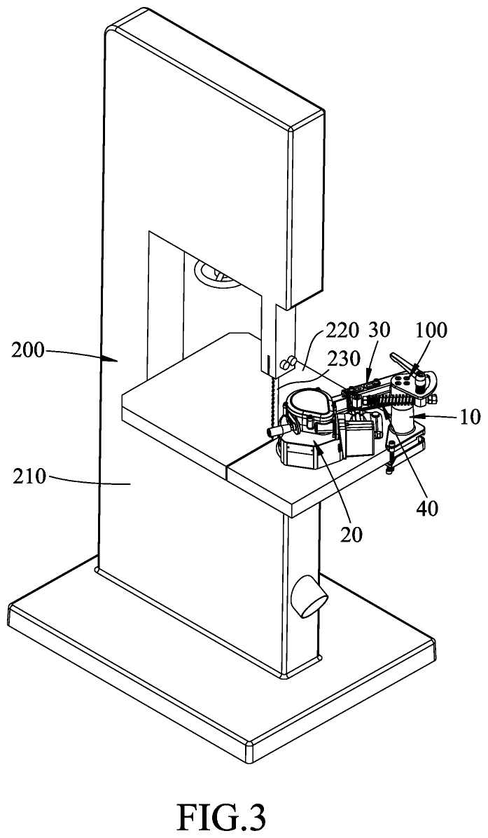

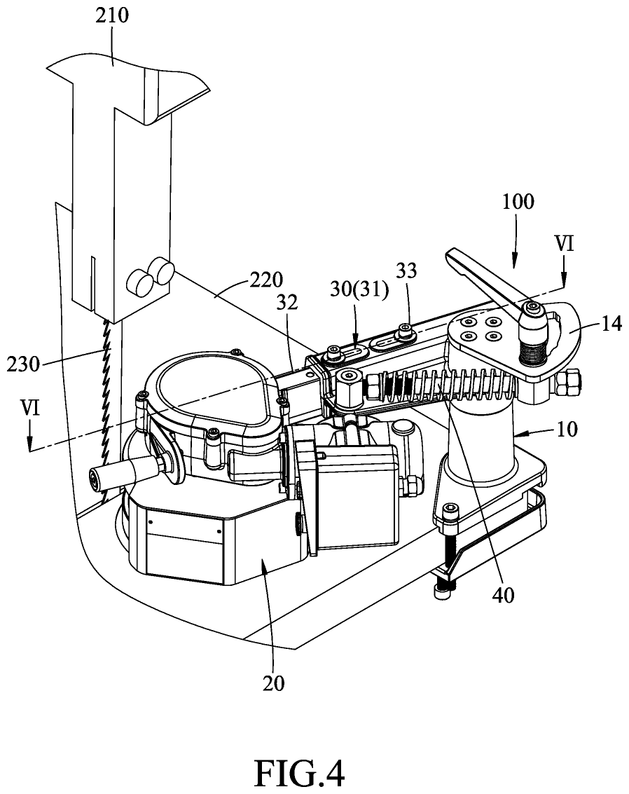

Referring to FIGS. 3 to 5, a feeding device 100 according to an embodiment of this disclosure adapted for feeding a workpiece to be machined by a machining device 200 is shown. The machining device 200 includes a machine body 210, a working table 220 mounted to the machine body 210, and a hacksaw blade 230 mounted to the machine body 210.

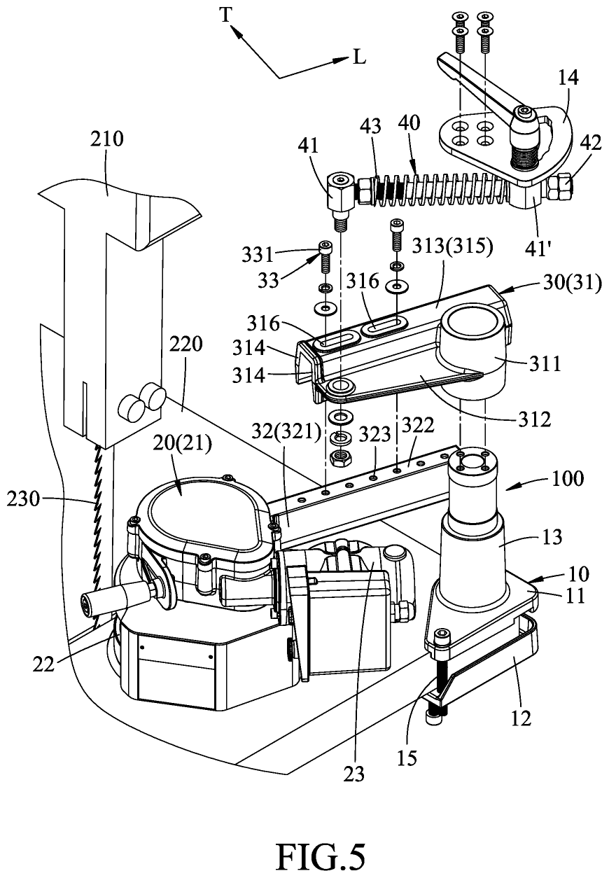

The feeding device 100 is mounted to the working table 220, and includes a support unit 10, a feeding unit 20, a connecting unit 30 and a biasing unit 40. As shown in FIG. 5, the support unit 10 includes an upper clamp half 11, a lower clamp half 12, a seat 13 and a plurality of fastening members 15 (only one is shown in the drawings). The upper clamp half 11 is disposed above the working table 220. The lower clamp half 12 is disposed under the working table 220, and corresponds in position to and cooperates with the upper clamp half 11 to clamp the working table 220 therebetween. The seat 13 protrudes from the upper clamp half 11 and has a cylinder profile. The fastening members 15 are for fastening the working table 220 between the upper clamp half 11 and the lower clamp half 12. In this embodiment, the fastening members 15 are bolts and screws but the present disclosure is not limited to this example.

The feeding unit 20 is disposed on the working table 220 and includes a housing 21, a delivery wheel 22 rotatably disposed in the housing 21 and a driving motor 23 mounted to the housing 21 for driving the delivery wheel 22 to rotate.

The connecting unit 30 is connected between the support unit 10 and the feeding unit 20, and includes a positioning member 31, an adjusting member 32 and a locking unit 33. The positioning member 31 is pivotally connected to the support unit 10, extends in a longitudinal direction (L), and includes an upright tube 311, a horizontal rib plate 312, and a slide sleeve 313. The upright tube 311 is rotatably sleeved on the seat 13 of the support unit 10 and is covered by the cover 14. The horizontal rib plate 312 is connected integrally to the slide sleeve 311. The slide sleeve 313 is connected integrally to the upright tube 311 and the horizontal rib plate 312, extends from the upright tube 311 in the longitudinal direction (L), includes two side walls 314 and a top wall 315, and has an inverted U-shaped cross section. The side walls 314 are spaced apart from each other in a transverse direction (T) transverse to the longitudinal direction (L). The top wall 315 interconnects top ends of the side walls 314 and is formed with at least one slot 316 extending in the longitudinal direction (L). In this embodiment, the top wall 315 is formed with two slots 316 spaced apart from each other in the longitudinal direction (L), and the horizontal rib plate 312 is connected integrally to one of the side walls 314.

The adjusting member 32 extends in the longitudinal direction (L), is telescopically connected to and sleeved in the slide sleeve 313 of the positioning member 31, has an inverted U-shaped cross section, and is movable relative to the slide sleeve 313 to adjust a distance between the feeding unit 20 and the support unit 10 in the longitudinal direction (L). The adjusting member 32 includes two upright walls 321 and a top wall 322. The upright walls 321 are spaced apart from each other in the transverse direction (T) and are disposed between the side walls 314. The top wall 322 is formed with a plurality of fastening holes 323 spaced apart from one another in the longitudinal direction (L) and interconnects the upright walls 321.

The locking unit 33 is for releaseably locking the slide sleeve 313 on the adjusting member 32. In this embodiment, the locking unit 33 includes two fastening elements 331. Each of the fastening elements 331 extends into a respective one of the slots 316 and a selected one of the fastening holes 323 to lock the adjusting member 32 on the slide sleeve 313 so as to prevent the adjusting member 32 from moving relative to the slide sleeve 313. On the other hand, when each of the fastening members 331 is removed from the respective one of the slots 316 and the selected one of the fastening holes 323, the adjusting member 32 is released from the slide sleeve 313 and is allowed to move relative to the slide sleeve 313 in the longitudinal direction (L).

The biasing unit 40 is connected between the support unit 10 and the horizontal rib plate 312 and is adapted for biasing the feeding unit 20 to rotate with the connecting unit 30 relative to the support unit 10 in a direction toward the machining device 200. Specifically, the biasing unit 40 includes a rotating member 41, a fixed member 41′, a horizontal connecting rod 42 and a coiled compression spring 43. The rotating member 41 is pivotally connected to the horizontal rib plate 312 and rotatable about a vertical axis transverse to the longitudinal direction (L) and the transverse direction (T). The fixed member 41′ is connected fixedly to the support unit 10 and is covered by the cover 14. The horizontal connecting rod 42 is connected fixedly to the rotating member 41 and is connected movably to the fixed member 41′. In this embodiment, the horizontal connecting rod 42 extends movably through the fixed member 41′. The coiled compression spring 43 is sleeved on the connecting rod 42 and is disposed between the fixed member 41′ and the rotating member 41 for biasing the rotating member 41 away from the fixed member 41′. Since the main feature of the present disclosure does not reside in the structure of the biasing member 40, further details of the same are omitted for the sake of brevity.

After the feeding device 100 of the present disclosure is mounted fixedly to the working table 220 by the upper and lower clamp halves 11, 12 and the fastening members 15, by virtue of both the positioning member 31 pivotally connected to the seat 13 of the support unit 10 and the feeding unit 20 connected to the adjusting member 32, the delivery wheel 22 is capable of delivering a workpiece to be machined by the machining device 200 when the motor 23 is turned on. In this embodiment, the machining device 200 is a wood sawing machine but the present disclosure is not limited to this example.

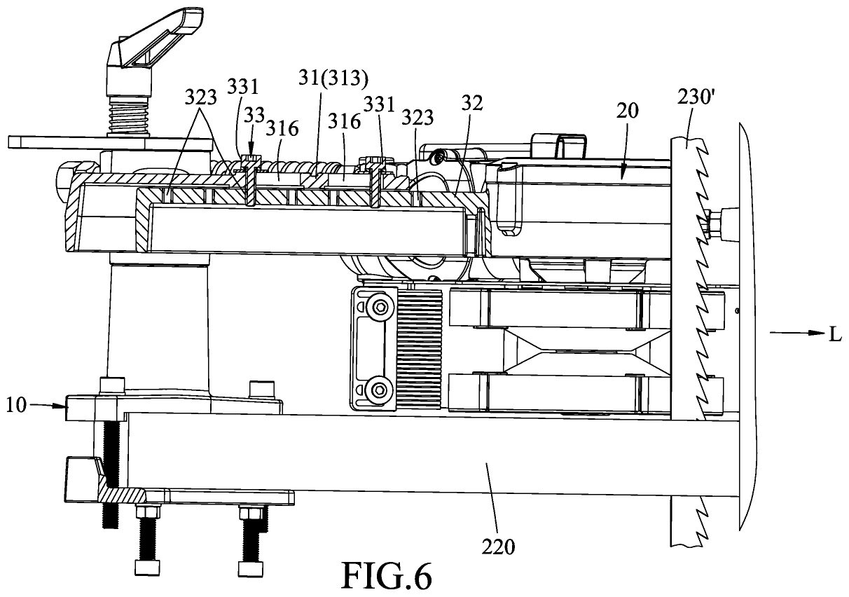

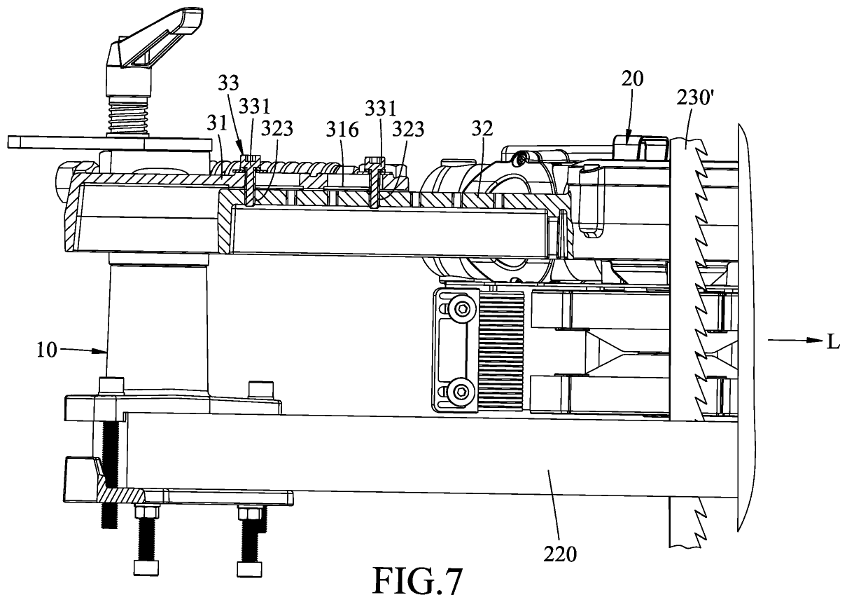

Referring to FIGS. 6 and 7, when it is required to use the feeding device 100 in different sized machining devices, a distance between the feeding unit 20 and the support unit 10 can be adjusted to maintain a distance between the feeding unit 20 and a blade 230′ of a machining device within a predetermined range. After the fastening elements 331 are loosened, the adjusting member 32 is released from the slide sleeve 313 and is allowed to move relative to the slide sleeve 313 toward the blade 230 (see FIG. 7), such that the distance between the feeding unit 20 and the support unit 10 is adjusted to a desired distance and thus the distance between the blade 230′ of the machining device and the feeding unit 20 is also adjusted to satisfy machining demand. Then, each of the fastening elements 331 is brought to extend into the respective one of the slots 316 and another selected one of the fastening holes 323 to fasten the adjusting member 32 back to the slide sleeve 313. In this way, as compared to the conventional feeding devices mentioned in the background section, by virtue of the feeding device 100 of the present disclosure, preparing several feeding devices is not required. Additionally, drilling through holes in the working table 220 is also not required. The configuration of two spaced-apart slots 316 and the fastening holes 323 allows the adjusting member 32 to move relative to the positioning member (31) in the longitudinal direction (L) by a relatively large distance.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A feeding device for a machining device, comprising:
a support unit;
a feeding unit adapted for feeding a workpiece to be machined by the machining device; and
a connecting unit connected between said support unit and said feeding unit, and including a positioning member pivotally connected to said support unit and extending in a longitudinal direction, an adjusting member telescopically connected to said positioning member and movable relative to said positioning member to adjust a distance between said feeding unit and said support unit in the longitudinal direction, and a locking unit for releaseably locking said adjusting member on said positioning member.

2. The feeding device as claimed in claim 1, wherein said positioning member is sleeved on said adjusting member and is formed with at least one slot extending in the longitudinal direction, said adjusting member being formed with a plurality of fastening holes spaced apart from one another in the longitudinal direction, said locking unit extending into said at least one slot and a selected one of said fastening holes so as to prevent said adjusting member from moving relative to said positioning member when said adjusting member is locked on said positioning member, and allow said adjusting member to move relative to said positioning member when said adjusting member is released from said positioning member.

3. The feeding device as claimed in claim 2, wherein said positioning member is formed with two of said slots that are spaced apart from each other in the longitudinal direction, said locking unit including two fastening elements extending respectively through said slots.

4. The feeding device as claimed in claim 1, wherein said positioning member includes an upright tube rotatably sleeved on said support unit, a slide sleeve extending from said upright tube in the longitudinal direction, having an inverted U-shaped cross section, and including two side walls spaced apart from each other in a transverse direction transverse to the longitudinal direction and a top wall that is formed with said at least one slot and that interconnects top ends of said side walls.

5. The feeding device as claimed in claim 4, wherein said adjusting member extends in the longitudinal direction, has an inverted U-shaped section, and includes two upright walls spaced apart from each other in the transverse direction and disposed between said side walls, and a top wall formed with said fastening holes and interconnecting said upright walls so as to guide said adjusting member to move along said positioning member in the longitudinal direction.

6. The feeding device as claimed in claim 4, further comprising a biasing unit connected between said support unit and said connecting unit and adapted for biasing said feeding unit to rotate with said connecting unit relative to said support unit in a direction toward the machining device.

7. The feeding device as claimed in claim 6, wherein said positioning member further includes a horizontal rib plate connected integrally to said slide sleeve, and said biasing unit includes a rotating member pivotally connected to said rib plate and rotatable about a vertical axis, a fixed member connected fixedly to said support unit, a horizontal connecting rod connected fixedly to said rotating member and connected movably to said fixed member, and a coiled compression spring sleeved on said connecting rod and disposed between said fixed member and said rotating member for biasing said rotating member away from said fixed member.

8. The feeding device as claimed in claim 1 further comprising a biasing unit connected between said support unit and said connecting unit, and adapted for biasing said feeding unit toward the machining device.
